(19) United States
(12) Patent Application Publication
(10) Pub. No.: US 2005/0032397 A1
(43) Pub. Date: Feb. 10, 2005

(54) Electrical connector assembly with readily removable pick-up cap

(76) Inventor: Yao-Chi Huang, Tu-chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/914,942

(22) Filed: Aug. 9, 2004

(30) Foreign Application Priority Data
Aug. 8, 2003 (TW) 92214450

(51) Int. Cl. H01R 13/60

(52) U.S. Cl. 439/41

(57) ABSTRACT

An electrical connector assembly includes an electrical connector (2) and a pick-up cap (1) mounted onto the connector. The connector (2) includes an insulative housing (20) having two opposite sidewalls (200, 201) thereon and a multiplicity of terminals (21) received therein. The pick-up cap includes a base portion (10), and a pair of extending portions (12) extending from opposite ends of the base portion respectively. A clasp (123) respectively depends from a corresponding distal end of the extending portion. A latching arm (124) interconnects distal end of the corresponding clasp. The housing defines corresponding latching protrusions (2004) on an outside of the sidewalls corresponding to the latching arms, respectively.

### BACKGROUND OF THE INVENTION

1. Field of the Invention

The present invention relates to an electrical connector assembly comprising an electrical connector and a pick-up cap mounted onto the connector for providing a plane top surface to be sucked by a vacuum suction device, whereby the connector assembly can be moved to a circuit substrate such as a printed circuit board (PCB) on which the electrical connector is to be mounted.

2. Description of the Prior Art

On many production lines, electronic components such as electrical connectors are accurately positioned on circuit substrates such as printed circuit boards (PCBs) by means of vacuum suction devices. This kind of electrical connector assembly is shown in U.S. Pat. No. 6,413,111 to LIAO FANG-CHU et al., dated Jul. 2, 2002.

Referring to FIGS. 5 and 6, a conventional electrical connector assembly is illustrated. The electrical connector assembly comprises an electrical connector 8 and a pick-up cap 9 mounted on the connector 8. The connector 8 comprises an insulative housing 80, and a multiplicity of electrical terminals 81 received in the housing 80. The housing 80 is substantially a rectangular configuration, and is formed from dielectric material such as LCP (liquid crystal polymer) that can endure soldering temperatures. The housing 80 defines a rectangular space 801 in a middle portion thereof for receiving an electrical package such as a central processing unit (CPU) therein, and the housing 80 comprises a pair of parallel, opposite sidewalls 800. A multiplicity of terminal-passages (not labeled) is defined in a portion of the housing 80 under the space 801, for receiving a corresponding number of the terminals 81 therein. Two latching protrusions 8000 are defined on outside middle portions of the sidewalls 800 respectively. A cross-section of each latching protrusion 8000 is generally triangular.

The pick-up cap 9 includes a base portion 91 having a plane top surface, and a first extending portion 92 and a second extending portion 93 extending from opposite ends of the base portion 91, respectively. The first and second extending portions 92, 93 are for being rested on the sidewalls 800, respectively. The first extending portion 92 comprises two parallel first arms 920, for being engaged in corresponding slots 802 of the sidewalls 800. The second extending portion 93 comprises two parallel second arms 930, for being engaged in corresponding slots of the other sidewall 800. A connecting portion 921 interconnects distal ends of the first arms 920, for facilitating a user in releasing the pick-up cap 9 from the connector 8. A pair of first clasps 922 depends from the distal ends of the first arms 920 respectively. A first latching arm 923 interconnects distal ends of the first clasps 922. The first clasps 922 and the first latching arm 923 cooperatively define a first socket 924 therebetween, for receiving a corresponding one of the latching protrusions 8000 of the housing 80 therein. A pair of second clasps 931 depends from distal ends of the second arms 930 respectively. A second latching arm 932 interconnects distal ends of the second clasps 931. The second clasps 931 and the second latching arm 932 cooperatively define a second socket 933 therebetween, for receiving the other latching protrusion 8000 of the housing 80 therein.

In assembly, the pick-up cap 9 is placed on the connector 8, with the first and second latching arms 923, 932 loosely resting on the corresponding sidewalls 800 respectively. Then, the pick-up cap 9 is pressed down. The first and second latching arms 923, 932 are deflected outwardly, and respectively ride along outer faces of the latching protrusions 8000 until the latching protrusions 8000 are received in the first and second sockets 924, 933 respectively. The pick-up cap 9 is thereby securely mounted onto the connector 8. A nozzle of the vacuum suction device (not shown) can then engage the plane surface of the base portion 90, in order to move the connector assembly 6 to a desired location on a PCB.

In the above-described assembly process, the latching protrusions 8000 are formed on respective outer faces of the sidewalls 800, and are engaged in the first and second sockets 924, 933. When the pick-up cap 9 is detached from the housing 80, a user applies force on the connecting portion 921 of the pick-up cap 9. This force is typically in an inclined direction, as indicated by arrow F in FIG. 6. Force F comprises the component force Fx acting along a direction parallel to the pick-up cap 9, and the component force Fy acting perpendicularly upwardly relative to force Fx. The effect of force Fx is to make the engagement between the pick-up cap 9 and the housing 80 tighter. As a result, it is difficult to detach the second latching arm 923 from the corresponding latching protrusion 8000. The force F applied on the connecting portion 921 needs to be considerable in order to be able to detach the pick-up cap 9 from the connector 8.

Thus, there is a need to provide a new electrical connector assembly that overcomes the above-mentioned disadvantages.

### SUMMARY OF THE INVENTION

Accordingly, one main object of the present invention is to provide an electrical connector assembly which has an electrical connector and a pick-up cap mounted on the connector, wherein the pick-up cap can be readily detached from the connector.

To achieve the above-mentioned object, an electrical connector assembly in accordance with a preferred embodiment comprises an electrical connector and a pick-up cap mounted on the electrical connector. The connector includes an insulative housing and a multiplicity of terminals received therein. The housing has four raised sidewalls and the four sidewalls cooperatively define a generally rectangular space therebetween for receiving an electronic package such as a central processing unit (CPU) therein. Two opposite sidewalls respectively define a central mounting portion therein. A latching protrusion is respectively formed on a corresponding outside of the two opposite central portion. A cross-section of the latching protrusions is generally rectangular, and each protrusion defines a recess in a lower surface thereof. The pick-up cap includes a base portion, two extending portions extending from opposite ends of the base portion respectively. Each extending portion comprises two parallel arms. A connecting portion interconnects distal ends of the arms. A clasp depends from the corresponding distal ends of one arm. A latching arm respectively extends from a distal end of the clasp, and a barb is defined in a free distal end of each latching arm. The clasp and the latching arm cooperatively define a L-shaped latch for engaging with the protrusion of the electrical connector.

In the assembly process, the pick-up cap is placed on the connector, with the two parallel arms loosely resting on the receiving recesses respectively. Then the pick-up cap is pushed horizontally, along the direction of the latching arm extending. The latching arm of each latch deflects downwardly, and moves relative to the protrusion portion until the barb of the arm is snappingly received in the recess of the lower surface of the protrusion portion. The pick-up cap is thereby securely mounted onto the connector.

Other objects, advantages and novel features of the present invention will become more apparent from the following detailed description when taken in conjunction with the accompanying drawings, in which:

### BRIEF DESCRIPTION OF THE DRAWINGS

FIG. 1 is a simplified, exploded, isometric view of an electrical connector assembly in accordance with the preferred embodiment of the present invention, the connector assembly comprising an electrical connector and a pick-up cap ready to be mounted onto the connector;

FIG. 2 is an isometric view of the electrical assembly, showing the pick-up cap loosely resting on the electrical connector, and the latch still not engaging with the latching protrusion;

FIG. 3 is similar to FIG. 2, but showing the latch engaging with the latching protrusion of the connector, with a bard of the latching arm in the notch of the latching protrusion;

FIG. 4 is an enlarged view of a circuit portion IV of FIG. 3;

FIG. 5 is a simplified, exploded, isometric view of a conventional electrical connector assembly; and

FIG. 6 is an assembled view of FIG. 5.

### DESCRIPTION OF PREFERRED EMBODIMENTS OF THE INVENTION

Reference will now be made to the drawings to describe the present invention in detail.

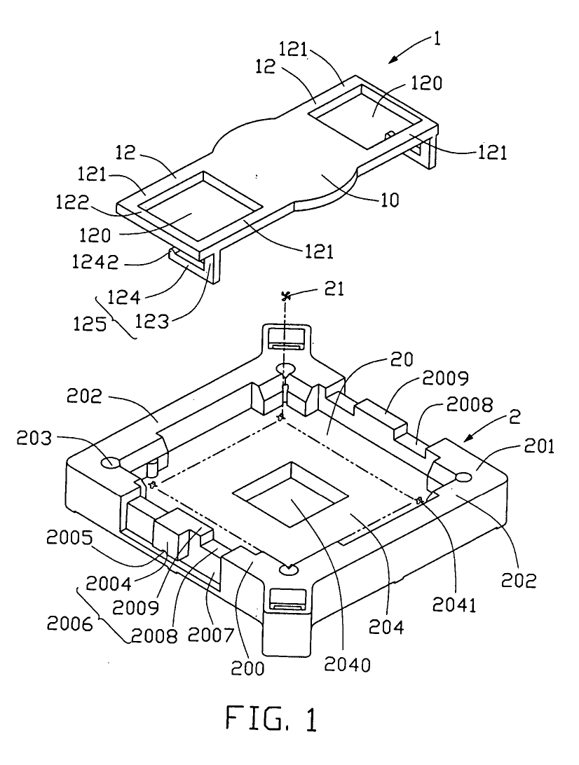

FIG. 1 shows a simplified, exploded isometric view of an electrical connector assembly in accordance with the preferred embodiment of the present invention. The electrical connector assembly comprises an electrical connector 2 and a pick-up cap 1. The pick-up cap 1 is mounted onto the connector 2, for providing a plane surface to be engaged by a vacuum suction device (not shown). The electrical connector assembly can thereby be moved to a circuit substrate, such as a printed circuit board (PCB) (not shown), on which the connector 2 is to be mounted.

The connector 2 comprises an insulative housing 20, and a multiplicity of terminals 21 received in the housing 20. The housing 20 is substantially a rectangular configuration, and is formed from dielectric material such as LCP (liquid crystal polymer) that can endure soldering temperatures. The housing 20 comprises a base 204, a first sidewall 200, a second sidewall 201 opposite to the first sidewall 200, and two opposite third sidewalls 202 interconnecting the first and second sidewalls 200, 201. The base 204 and the first, second and third sidewalls 200, 201, 202 cooperatively define a space therebetween for receiving a CPU package (not shown) therein. The base 204 defines a rectangular cavity 2040 in a middle thereof. A multiplicity of terminal-passages 2041 is defined in the base 204 around the cavity 2040, for receiving a corresponding number of the terminals 21 therein.

The first and second sidewalls 200, 201 respectively define central mounting portions 2006 thereof, for receiving the pick up cap 1 thereon. The mounting portion 2006 comprises a raised central portion 2009, a pair of receiving recesses 2008 defined at two sides of the central portion 2009, and a latching protrusion 2004 communicating with the central portion 2009. The latching protrusion 2004 extends outside from the corresponding sidewall. A side surface 2007 beside the latching protrusion is sunk the sidewall thereof, for facilitating resting of the pick-up cap 1 onto the housing 20. The latching protrusion 2004 comprises a lower surface (not labeled), and a notch 2005 is defined on the lower surface. A cross-section of the latching protrusion 2004 is generally rectangular. Four circular holes 203 are defined in four corners of the housing 20 respectively, for insertion of fasteners (not shown) therethrough in order to mount the connector 2 onto the PCB.

The pick-up cap 1 comprises a base portion 10 having a plane top surface, and a pair of extending portions 12 extending from opposite ends of the base portion 10 respectively. Each extending portion 12 comprises two parallel arms 121, for being received in the receiving recesses 2008 of the housing 20. A connecting portion 122 interconnects distal ends of the two parallel arms 121. The arms 121, the connecting portion 122, and the base portion 10 cooperatively define a through hole 120 therebetween. A clasp 123 depends form a corresponding distal end of one arm 121 of the extending portion 12, and a distal end of the clasp 123 defines a latching arm 124. The latching arm 124 is substantially parallel to the connecting portion 122, and a barb 1242 is defined in a free distal end thereof. The clasp 123 and the latching arm 124 cooperatively define a L-shaped latch 125 for engaging with the latching protrusion 2004 of the electrical connector 2.

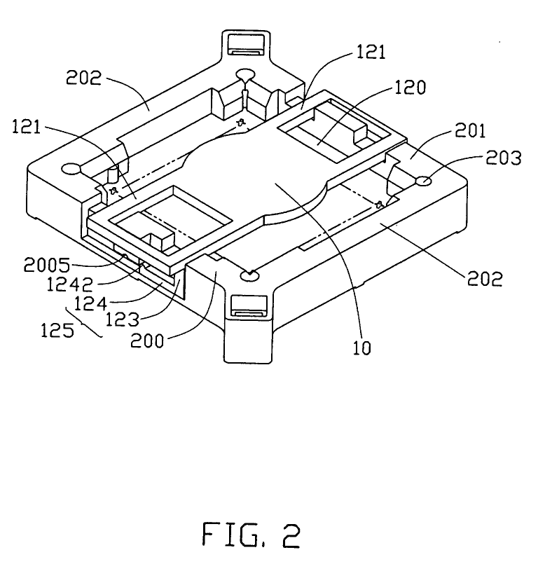

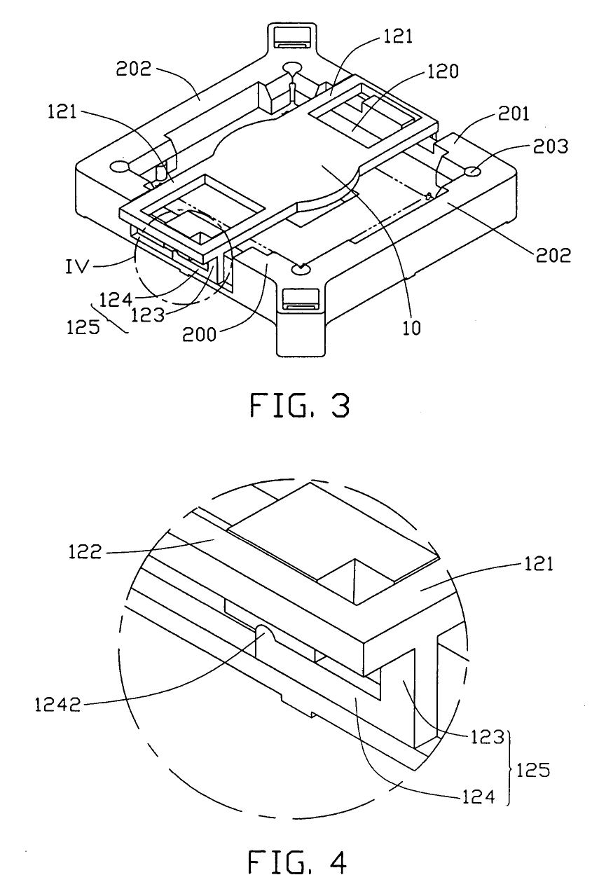

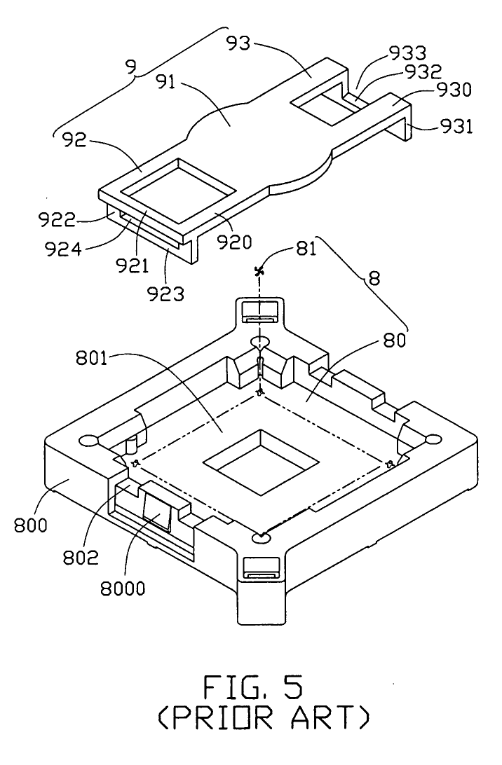

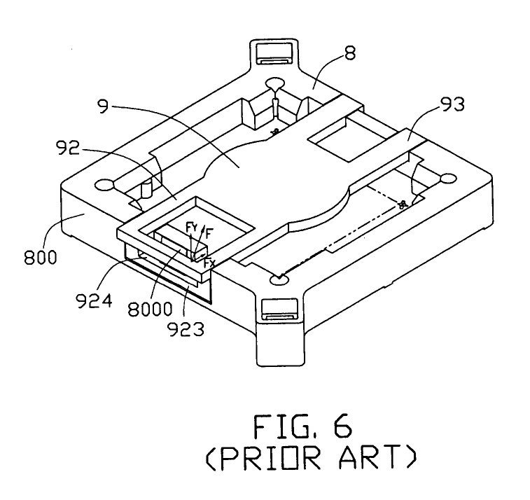

Referring to FIGS. 2 to 4, in assembly of the electrical connector assembly, the pick-up cap 1 is placed on the connector 2, with the latch 125 loosely contact with the side surface 2007 and the two parallel arms 12 loosely resting on the receiving recesses 2008 respectively. Then the pick-up cap 1 is pushed horizontally, along the direction of the latching arm 124 extending. The latching arm 124 of each latch 125 deflects downwardly, and moves relative to the protrusion portion 2004 until the barb 1242 of the latching arm 124 is snappingly received in the notch 2005 of the lower surface of the protrusion portion 2004. The pick-up cap 1 is thereby securely mounted onto the connector 2. A nozzle of the vacuum suction device (not shown) can then engage the plane surface of the base portion 10, in order to move the connector assembly to a desired location on the PCB.

When the pick-up cap 1 is subsequently detached from the connector 2, a user applies force on the base portion 10 of the pick-up cap 3. This force is typically in a horizontal direction, opposite to the direction of the latching arms 124 extending. The force operates to disengage the barb 1242 of the latching 22 from the notch 2005 of the protrusion portion 2004 and push the latching arm 124 of the pick-up cap 1 backwardly until the latching arm 124 does not contact with the lower surface of the protrusion portion 2004. Then, a vertical force is applied to remove the pick-up cap 1. Therefore, the pick-up cap 1 is convenient to be mounted onto and detached from the connector 2.

Although the present invention has been described with reference to particular embodiment, it is not to be construed as being limited thereto. Various alterations and modifications can be made to the embodiment without in any way departing from the scope or spirit of the present invention as defined in the appended claims.

1. An electrical connector assembly comprising:
an electrical connector comprising:
an insulative housing defining a plurality of sidewalls adapted for receiving an electronic package therein, two opposite sidewalls each defining a mounting portion thereof, the mounting portion comprising a latching protrusion on an outside of the sidewall thereof; the latching protrusion defines a lower surface, and
a plurality of terminals received in the housing;
a pick-up cap mounted on the housing and comprising:
a base portion having a planar top surface to be sucked by a vacuum suction device; and
two extending portions extending from two opposite ends of the base portion;
wherein each extending portion defines a clasp depending from the extending portion, and a distal end of the clasp defines a latching arm for engaging with the lower surface of the latching protrusion.

2. The electrical connector assembly of claim 1, wherein a free distal end of the latching arm defines a barb, and the lower surface of the latching protrusion defines a notch for engaging with the barb.

3. The electrical connector assembly of claim 1, wherein the mounting portion further comprises a raised central portion and a pair of receiving recesses defined at two side of the central portion.

4. The electrical connector assembly of claim 3, wherein the extending portion comprises a pair of parallel arms and a connecting portion interconnecting distal ends of the two parallel arms.

5. The electrical connector assembly of claim 4, wherein the parallel arms and the connecting portion cooperatively defines a through hole for receiving the raise portion of the mounting portion.

6. The electrical connector assembly of claim 1, wherein a side surface beside the latching protrusion is sunk into the sidewall thereof.

7. The electrical connector assembly of claim 1, wherein a cross-section of the latching protrusion is generally triangular.

8. An electrical connector assembly comprising:
an electrical connector comprising:
an insulative housing defining a plurality of sidewalls adapted for receiving an electronic package therein, two opposite sidewalls each defining a latching protrusion on an outside thereof; the latching protrusion defines a lower surface, and
a plurality of terminals received in the housing;
a pick-up cap mounted on the housing and comprising:
a base portion having a planar top surface to be sucked by a vacuum suction device; and
two extending portions extending from two opposite ends of the base portion;
wherein each extending portion defines a substantially L-shaped latch, and the latch engages or disengages with the latching protrusion when the pick-up cap is pushed horizontally.

9. The electrical connector assembly of claim 8, wherein the L-shaped latch comprises a clasp depending from the extending portion, a latching arm extending from a distal end of the clasp for engaging with the lower surface of the latching protrusion.

10. The electrical connector assembly of claim 8, wherein a free distal end of the latching arm defines a barb, and the lower surface of the latching protrusion defines a notch for engaging with the barb.

11. The electrical connector assembly of claim 8, wherein the extending portion comprises a pair of parallel arms and a connecting portion interconnecting distal ends of the two parallel arms.

12. The electrical connector assembly of claim 8, wherein a side surface beside the latching protrusion is sunk into the sidewall thereof.

13. The electrical connector assembly of claim 8, wherein a cross-section of the latching protrusion is generally triangular.

14. An electrical connector assembly comprising:
an electrical connector comprising:
an insulative housing defining a plurality of sidewalls adapted for receiving an electronic package therein, two opposite sidewalls each defining a mounting portion thereof, the mounting portion comprising a latching protrusion on an outside of the sidewall thereof; the latching protrusion defines a lower surface, a space located beside said protrusion, and
a plurality of terminals received in the housing;
a pick-up cap mounted on the housing and comprising:
a base portion having a planar top surface to be sucked by a vacuum suction device; and
two extending portions extending from two opposite ends of the base portion; wherein
said pick-up is initially downwardly installed unto the housing in a perpendicular direction to have the extending portions inserted into the corresponding spaces, respectively, and successively is moved in a horizontal direction to have the extending portions abut against the lower surfaces in the vertical direction for latching to pick-up to the housing.
